(19) United States
(12) Patent Application Publication
(10) Pub. No.: US 2011/0019421 A1
(43) Pub. Date: Jan. 27, 2011

(54) TUBULAR LED ILLUMINATING DEVICE WITH 360-DEGREE RADIATION

(75) Inventor: CHIH-MING LAI, Chu-Nan (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXSEMICON INTEGRATED TECHNOLOGY, INC., Chu-Nan (TW)

(21) Appl. No.: 12/622,718

(22) Filed: Nov. 20, 2009

(30) Foreign Application Priority Data
Jul. 21, 2009 (CN) 200910304608.2

(51) Int. Cl. F21S 4/00

(52) U.S. Cl. 362/249.06; 362/249.02

(57) ABSTRACT

A tubular LED illuminating device comprises a tubular shell, a supporting frame and a plurality of light emitting units. An inner surface of the shell forms a plurality of elongate protrusions extending along a direction parallel to an axial direction of the shell. Each of the protrusions defines at least one elongate recess extending along the axial direction of the shell. The supporting frame is received in the shell and comprises at least three supporting plates. Two opposite edges of each supporting plate are respectively embedded in the adjacent recesses of different protrusions. The light emitting units are arranged on the at least three supporting plates, and light emitted from the light emitting units emits out through the shell and has a radiation angle of 360 degrees.

### BACKGROUND

1. Technical Field

The present disclosure generally relates to an LED illuminating device, and more particularly to a tubular LED illuminating device which has a radiation angle about 360 degrees, whereby the tubular LED illuminating device can have a light field distribution similar to that of a conventional fluorescent tube.

2. Discussion of Related Art

With the continuing development of scientific technology, light emitting diodes (LEDs) have been widely used in illumination devices to substitute for conventional cold cathode fluorescent lamps (CCFL) and conventional fluorescent tubes due to their high brightness, long life-span, and wide color gamut.

Conventional tubular LED illuminating devices incorporating LEDs generally generate butterfly-type light fields or have a radiation angle about 120 degrees. Referring to FIG. 6, a radiation angle of a conventional tubular LED illuminating device which is about 120 degrees is shown. However, this type of light field is not suitable for illumination, particularly when the tubular LED illuminating device is constructed to replace the conventional fluorescent tube, which has a 360-degree light field distribution.

What is needed, therefore, is a tubular LED illuminating device having a 360-degree radiation.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views, wherein:

FIG. 1 is a perspective view of a tubular LED illuminating device, in accordance with a first embodiment of the present disclosure.

FIG. 2 is a cross-sectional view of the tubular LED illuminating device, taken along line II-II of FIG. 1.

FIG. 3 is a light field of the tubular LED illuminating device, in accordance with the first embodiment of the present disclosure.

FIG. 4 is a cross-sectional view of a tubular LED illuminating device, in accordance with a second embodiment of the present disclosure.

FIG. 5 is a cross-sectional view of a tubular LED illuminating device according to a first variation of the second embodiment.

FIG. 6 is a graph showing a light field of a conventional tubular LED illuminating device.

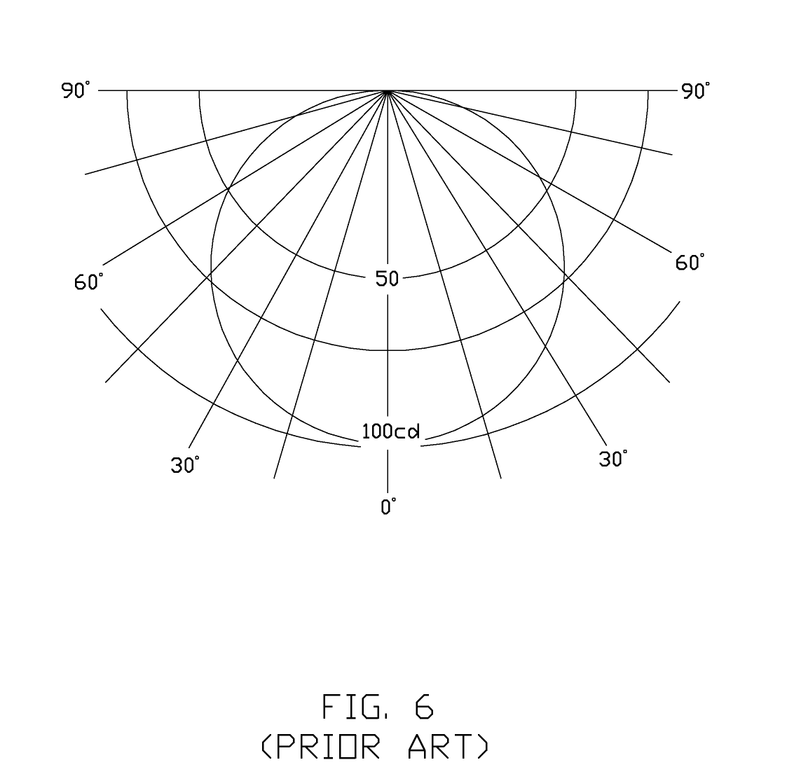

### DETAILED DESCRIPTION OF THE PREFERRED EMBODIMENTS

Reference will now be made to the drawings to describe the embodiments of the present tubular LED illuminating device in detail.

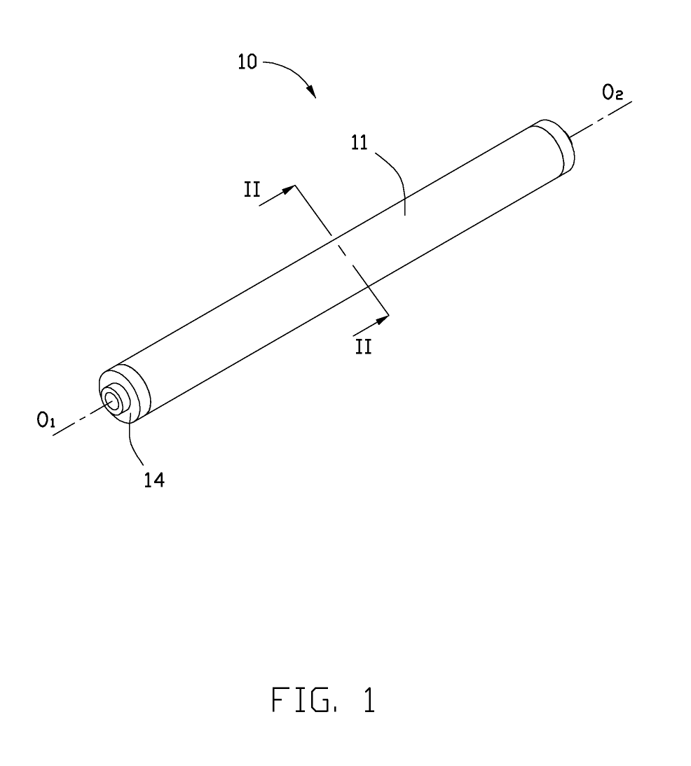

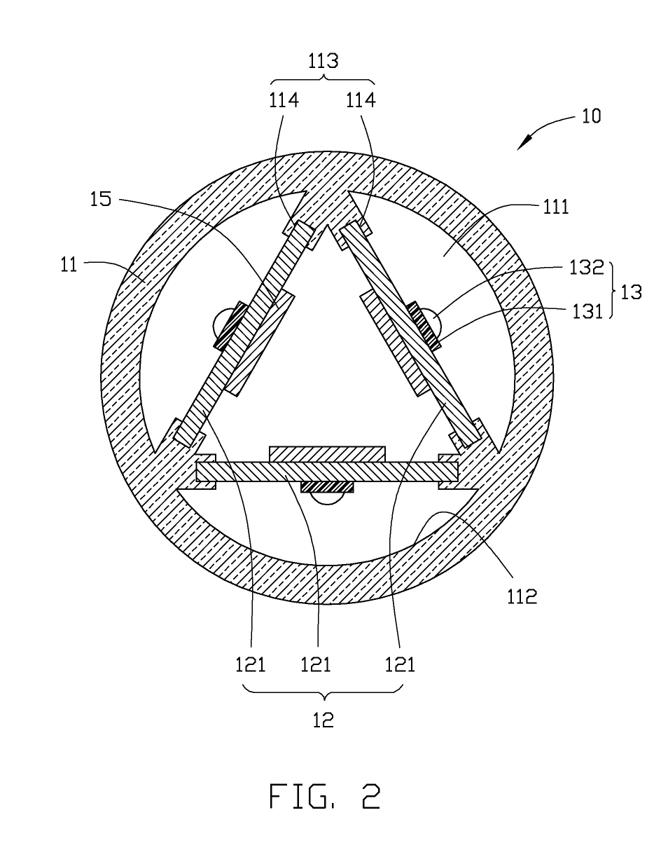

Referring to FIGS. 1 and 2, a tubular LED illuminating device 10 according to a first exemplary embodiment of the present disclosure is provided. The illuminating device 10 includes a tubular shell 11, a supporting frame 12 and a plurality of (i.e., three) elongated light emitting units 13.

The shell 11 defines a chamber 111 therein and has an inner surface 112. The inner surface 112 forms three elongate protrusions 113 protruding radially inwardly from the inner surface 112 of the shell 11 and extending along a direction parallel to an axial direction (i.e., O₁-O₂ direction) of the shell 11. In the present embodiment, the protrusions 113 are integrally formed with the shell 11 and arranged symmetrically about the circumferential direction of the shell 11. An extremity end of each of the protrusions 113 defines two elongate recesses 114 extending along the axial direction of the shell 11. In the present embodiment, a cross-section view of the recess 114 is generally U-shaped. In alternative embodiments, the cross-section view of the recess 114 may be V-shaped. The shell 11 is made of a light-pervious material such as glass, plastic, or the like.

The supporting frame 12 is received in the shell 11. In the present embodiment, the supporting frame 12 includes three elongate supporting plates 121. Two opposite edges of each supporting plate 121 are respectively embedded in the adjacent recesses 114 of different protrusions 113. The supporting plate 121 is made of thermal conductive material, such as copper, aluminum, or iron, so it can be used for absorbing heat from the light emitting unit 13 of the illuminating device 10.

The light emitting units 13 are arranged on outer sides of the three supporting plates 121, and in position facing the inner surface 112 of the shell 11. In the present embodiment, the light emitting unit 13 on each supporting plate 121 is arranged on a central line of the corresponding supporting plate 121. Each of the light emitting units 13 includes a substrate 131 and a plurality of light emitting elements 132 arranged in a line on the substrate 131. The light emitting elements 132 are light emitting diodes (LEDs). Light emitted from the light emitting units 132 emits out through the shell 11. In the present embodiment, the light emitting units 132 arranged on different supporting plate 121 have the same brightness and the radiation angle of each light emitting unit 132 is equal to or greater than 120 degrees.

In the present embodiment, the illuminating device 10 further comprises two end caps 14 and a heat dissipation module 15. The two end caps 14 are disposed at opposite ends of the shell 11 and configured for connecting with an exterior element, such as a conventional fluorescent lamp holder (not shown). The heat dissipation module 15 is arranged on inner sides of the supporting plates 121, away from the light emitting units 13.

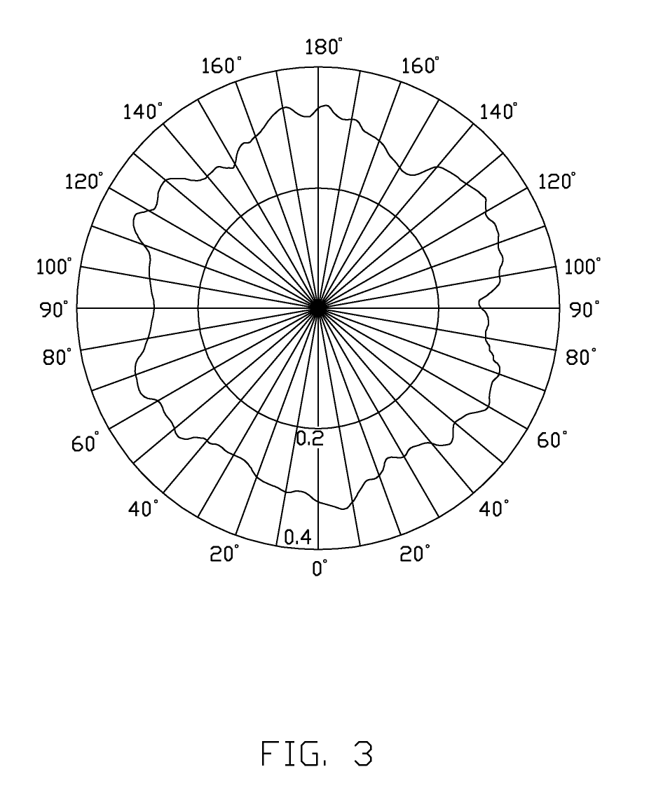

Referring to FIG. 3, in the present embodiment, the radiation angle of the illuminating device 10 is 360 degrees. Furthermore, the type of the light field of the illuminating device 10 is a diffusion-type light field; in other words, a part of the light field along an x-direction is substantially the same as a part of the light field along a y-direction. Thus the light emission of the illuminating device 10 can be substantially evenly distributed, and the illuminating device 10 can be fit for replacing a conventional fluorescent tube. Furthermore, each supporting plate 121 is embedded in the recesses 111; thus, assembling and manufacturing of the illuminating device 10 can be simplified.

It will be understood that in alternative embodiments, more than three supporting plates 121 and more than three light emitting units 13 can be employed.

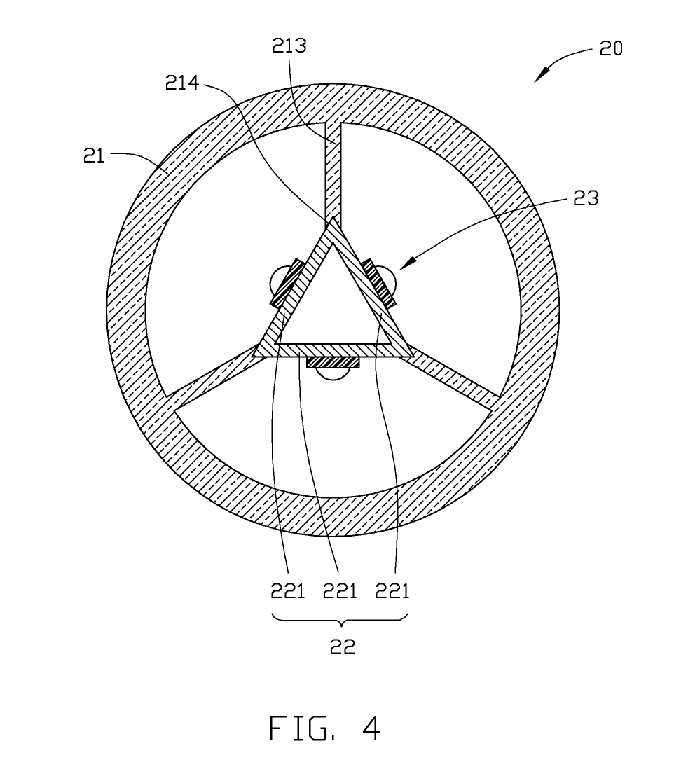

Referring to FIG. 4, a tubular LED illuminating device 20 according to a second exemplary embodiment includes a tubular shell 21, a supporting frame 22 and a plurality of light emitting units 23. The configuration of the illuminating device 20 is similar to that of the illuminating device 10; the main difference between them is the three supporting plates 221 which connect end to end to form a triangular prism. Each protrusion 213 defines one elongate recess 214 extending along the axial direction of the shell 21. The cross-section view of the recess 214 is V-shaped. The three apexes of the triangular prism are embedded in the three recesses 214 of the protrusions 213. In the present embodiment, the three protrusions 213 are arranged symmetrically about the circumferential direction of the shell 21, and the triangular prism formed by the three supporting plates 221 is a regular triangular prism. It can be understood that a heat dissipation apparatus can be arranged on inner sides of the supporting plates 121, away from the light emitting units 23.

The illuminating device 20 has advantages similar to those of the illuminating device 10. The radiation angle of the illuminating device 20 is 360 degrees, and light emission of illuminating device 20 can be substantially evenly distributed; thus the illuminating device 20 is fit for replacing a conventional fluorescent tube. Furthermore, the three supporting plates 221 connect end to end to form the triangular prism; the three supporting plates 221 can be easily embedded in or extracted from the recesses 214 at the same time; thus assembling and manufacturing of the illuminating device 10 can be simplified and time-saving.

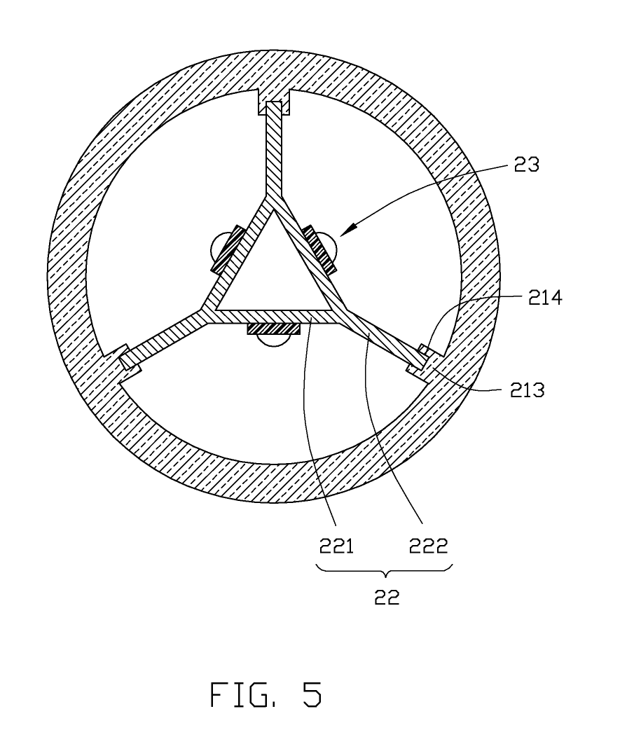

In the present embodiment, the cross-section view of the recess 214 is not limited to be V-shaped. Referring to FIG. 5, in accordance with a variation of the second embodiment, the cross-section view of the recess 214 can also be U-shaped. The illuminating device 20 can further comprise three connecting boards 222. The three supporting plates 221 connect end to end to form the triangular prism. One end of each connecting board 222 integrally connects to an apex of the triangular prism and the other end thereof is embedded in the recess 214 defined in the extremity end of a corresponding protrusion 213. In the present embodiment, the triangular prism formed by the three supporting plates 221 is a regular triangular prism. The three connecting boards 222 are integrally formed with the three supporting plates 221.

It is to be further understood that even though numerous characteristics and advantages have been set forth in the foregoing description of embodiments, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An illuminating device, comprising:
a tubular shell, an inner surface of the shell forming a plurality of elongate protrusions extending along a direction parallel to an axial direction of the shell, each of the protrusions defining at least one elongate recess extending along the axial direction of the shell;
a supporting frame being received in the shell and comprising at least three supporting plates, two opposite edges of each supporting plate respectively embedding in adjacent recesses of different protrusions; and
a plurality of light emitting units arranged on the at least three supporting plates, and light emitted from the light emitting units emitting out through the shell, each light emitting unit including a plurality of LEDs;
wherein the light emitted from the light emitting units is substantially evenly distributed over a 360-degree light field around the tubular shell.

2. The illuminating device according to claim 1, wherein the inner surface of the shell forms three elongate protrusions and each protrusion defines two recesses, and the supporting frame comprises three supporting plates, two opposite edges of each supporting plate respectively embedded in the adjacent recesses of different protrusions.

3. The illuminating device according to claim 2, wherein the three protrusions are arranged symmetrically about a circumferential direction of the shell.

4. The illuminating device according to claim 1, wherein the inner surface of the shell forms three elongate protrusions and each protrusion defines one recess, and the supporting frame comprises three supporting plates which connect end to end to form a triangular prism, three apexes of the triangular prism embedded in the three recesses of the protrusions.

5. The illuminating device according to claim 4, wherein the three protrusions are arranged symmetrically about a circumferential direction of the shell, and the triangular prism formed by the three supporting plates is a regular triangular prism.

6. The illuminating device according to claim 4, wherein the inner surface of the shell forms three elongate protrusions and each protrusion defines one recess, and the supporting frame comprises three supporting plates and three connecting boards, the three supporting plates connect end to end to form a triangular prism, and one end of each connecting board connects to an apex of the triangular prism and another end of each connecting board embedded in a corresponding recess.

7. The illuminating device according to claim 6, wherein the three protrusions are arranged symmetrically about a circumferential direction of the shell, and the triangular prism formed by the three supporting plates is a regular triangular prism.

8. The illuminating device according to claim 6, wherein the three connecting boards are integrally formed with the three supporting plates.

9. The illuminating device according to claim 1, wherein each light emitting unit is elongated and includes a substrate, the plurality of LEDs being arranged in a line on the substrate.

10. The illuminating device according to claim 1, further comprising a heat dissipation module arranged on the supporting plates and away from the light emitting units.

11. The illuminating device according to claim 1, wherein the protrusions are integrally formed with the shell.

12. The illuminating device according to claim 1, wherein a cross-section view of the at least one elongate recess is V-shaped.

13. The illuminating device according to claim 1, wherein a cross-section view of the at least one elongate recess is U-shaped.

14. An illuminating device, comprising:
a tubular shell, an inner surface of the shell forming a plurality of elongate protrusions extending along a direction parallel to an axial direction of the shell, each of the protrusions defining at least one elongate recess extending along the axial direction of the shell;
a plurality of supporting plates being received in the shell, and two opposite edges of each supporting plate respectively embedded in corresponding ones of the recesses;
a plurality of light emitting units arranged on the supporting plates, and light emitted from the light emitting units emitting out through the shell and a radiation angle of the light of the illuminating device being 360 degrees around the tubular shell.

15. The illuminating device according to claim 14, wherein the inner surface of the shell forms three elongate protrusions, and each protrusion defines one recess, the illuminating device comprises three supporting plates which connect end to end to form a triangular prism, three apexes of the prism embedded in the three recesses of the protrusions.

16. The illumination device according to claim 14, further comprising two caps secured at two ends of the tubular shell, adapted for connecting with a fluorescent lamp holder.
